(19) United States
(12) Patent Application Publication
(10) Pub. No.: US 2017/0059767 A1
(43) Pub. Date: Mar. 2, 2017

(54) LED STRIP, BACKLIGHT AND DISPLAY DEVICE

(71) Applicants: BOE Technology Group Co., Ltd., Beijing (CN); Beijing BOE CHATANI Electronics Co., Ltd., Beijing (CN)

(72) Inventor: Qiang LI, Beijing (CN)

(21) Appl. No.: 15/021,080

(22) PCT Filed: Oct. 18, 2015
(86) PCT No.: PCT/CN2015/092149

§ 371 Date: Mar. 10, 2016

(30) Foreign Application Priority Data
Apr. 21, 2015 (CN) 201520241976.8

(51) Int. Cl. F21V 8/00; F21V 19/00; F21V 15/01

(52) U.S. Cl. CPC G02B 6/0078; G02B 6/0051; G02B 6/0083; G02B 6/0085; G02B 6/0031; F21V 15/01; F21V 19/005; F21Y 2115/10

(57) ABSTRACT

An LED strip comprises: a support plate (15) provided with a circuit layer (C), the support plate (15) including a first plate portion (24) and a second plate portion (16) connecting and intersecting with each other; a plurality of LED chips (13) disposed on a first side and a second side of the second plate portion (16) of the support plate (15), the respective LED chips (13) being respectively electrically connected with the circuit layer (C); and a transparent protective layer (12) for encapsulating the plurality of LED chips (13) on the second plate portion (16) of the support plate (15). A backlight (22) and a display device are further provided. Such strip is capable of solving a problem that a display effect of the display device is affected due to a small light emitting angle of a LED strip.

### TECHNICAL FIELD

Embodiments of the present disclosure relate to an LED strip, a backlight and a display device.

### BACKGROUND

A Light Emitting Diode Strip (hereinafter briefly referred to as an LED strip) is a solid-state semiconductor device which can convert electrical energy into visible light, and is commonly used in a backlight of a display device.

### SUMMARY

An embodiment of the present disclosure provides an LED strip, comprising: a support plate provided with a circuit layer, the support plate including a first plate portion and a second plate portion connecting and intersecting with each other; a plurality of LED chips disposed on a first side and a second side of the second plate portion of the support plate, the respective LED chips being respectively electrically connected with the circuit layer; and a transparent protective layer for encapsulating the plurality of LED chips on the second plate portion of the support plate.

Alternatively, the second plate portion is perpendicular to the first plate portion.

Alternatively, the support plate is a T-shaped thermal conductive plate.

Alternatively, an amount and an arrangement mode of the LED chips on the first side of the second plate portion of the support plate are same as an amount and an arrangement mode of the LED chips on the second side of the second plate portion of the support plate, and the first side is opposite to the second side.

Alternatively, each of the LED chips is fixed to the second plate portion of the support plate by thermal conductive adhesive.

Alternatively, the transparent protective layer is a resin protective layer.

Alternatively, the LED chip is electrically connected with the circuit layer through a lead.

Alternatively, the support plate includes an aluminium plate.

Another embodiment of the present disclosure provides a backlight, comprising: a frame; at least two light guide modules arranged at intervals in the frame; and the LED strip according to any one of the above being disposed between two adjacent light guide modules.

Alternatively, the at least two light guide modules are two light guide modules, and the LED strip is located between the two light guide modules.

Alternatively, a diffusion sheet is disposed on a light emergent surface of the light guide module, and in the diffusion sheet, a diffusion particle density gradually decreases in a direction away from the LED strip.

A further embodiment of the present disclosure provides a display device, comprising a display panel, and the backlight according to any one of the above.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the disclosure.

FIG. 1 is a structural schematic diagram of an LED strip in a related art;

FIG. 2 is a cross-sectional diagram of an LED strip according to an embodiment of the present disclosure;

FIG. 3 is a cross-sectional diagram of a vertical portion of the LED strip according to the embodiment of the present disclosure;

FIG. 4 is a cross-sectional diagram of the vertical portion of the LED strip according to the embodiment of the present disclosure;

FIG. 5 is cross-sectional structural schematic diagram of a backlight according to an embodiment of the present disclosure;

FIG. 6 is a planar schematic diagram of a diffusion sheet in the backlight according to the embodiment of the present disclosure;

FIG. 7 is a structural schematic diagram of a display device according to an embodiment of the present disclosure.

### DETAILED DESCRIPTION

The technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

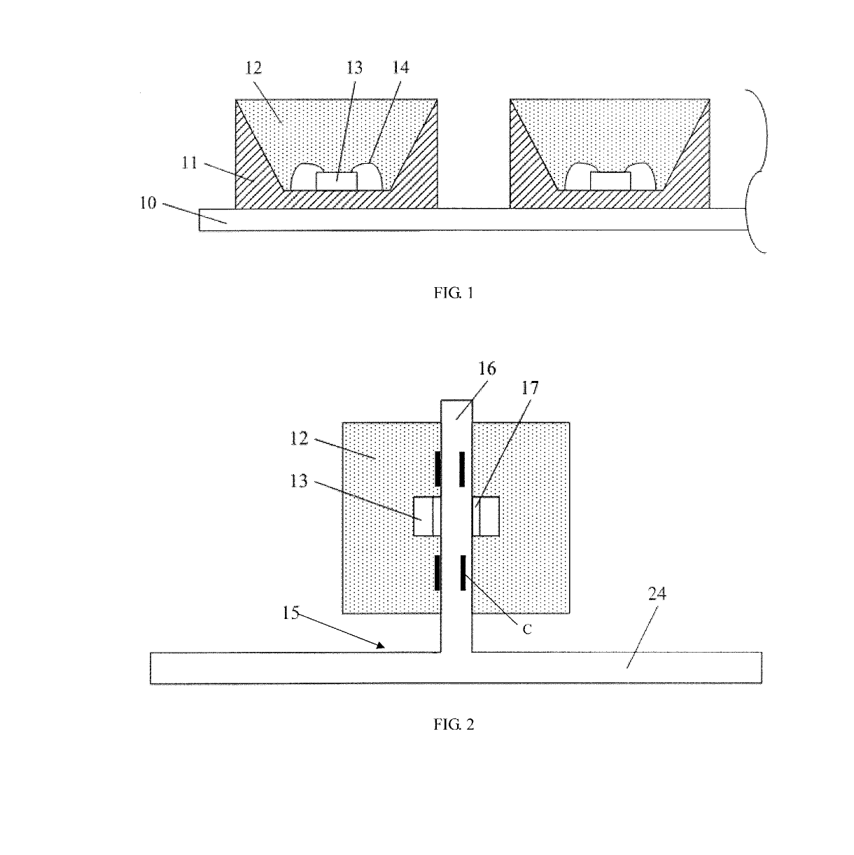

The LED strip in a related art is as shown in FIG. 1. The LED strip comprises a printed circuit board (hereinafter briefly referred to as a PCB) 10, and a plurality of LED lamps installed on the PCB 10. Each of the LED lamps includes a support frame 11, an LED chip 13 disposed on the support frame 11, a lead 14 connecting the LED chip 13 and the support frame, and a transparent protective layer 12 for encapsulating the LED chip 13 on the support frame.

However, inventor of the present application have found that: a light emitting angle of each LED lamp in the LED strip in the related art is relatively small, which is about 120°, so that an overall light emitting angle of the LED strip is also relatively small, a dark regions due to the small light emitting angle of the LED strip may occur to the display device, which further affects a display effect of the display device.

Embodiments of the present disclosure provide an LED strip, a backlight and a display device, capable of increasing the light emitting angle of the LED strip, and improving the display effect of the display device.

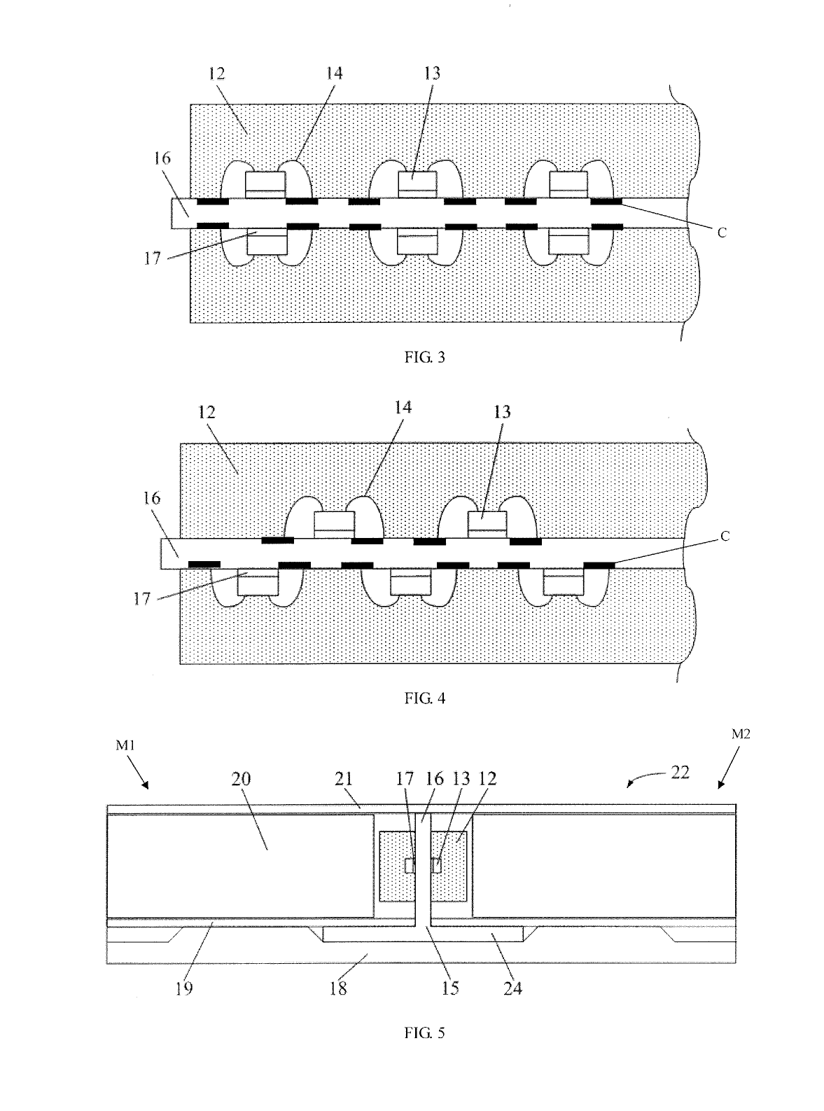

With reference to FIG. 2, FIG. 3 and FIG. 4, the LED strip provided by the embodiment of the present disclosure comprises: a T-shaped thermal conductive plate 15 provided with a circuit layer C, a plurality of LED chips 13 installed on the T-shaped thermal conductive plate 15, wherein the T-shaped thermal conductive plate 15 includes a horizontal portion 24 disposed within a horizontal plane, and a vertical portion 16 vertically disposed on the horizontal portion 24, and the plurality of LED chips 13 are arranged on two opposite sides of the vertical portion 16 of the T-shaped thermal conductive plate 15. Here, the T-shaped thermal conductive plate 15 refers to that the thermal conductive plate 15 has a cross-sectional structure resembling a T shape. With reference to FIG. 2, the T-shaped thermal conductive plate 15 as a whole may extend in a direction perpendicular to a paper plane.

For example, positions and number of the LED chips on the two opposite sides of the vertical portion 16 of the T-shaped thermal conductive plate 15 may be set according to requirements on brightness degree and brightness distribution of the display effect of the display device. For example, as shown in FIG. 3, the LED chips 13 on the two sides of the vertical portion 16 may be arranged uniformly to align with one another; or, as shown in FIG. 4; also, the LED chips 13 on the two sides of the vertical portion 16 may be arranged alternately.

With continued reference to FIG. 2, FIG. 3 and FIG. 4, the respective LED chips 13 are electrically connected with the circuit layer C on the T-shaped thermal conductive plate 15, and the plurality of LED chips 13 are encapsulated within the transparent protective layer 12 on the vertical portion 16 of the T-shaped thermal conductive plate 15, wherein, the LED chips 13 on one side of the vertical portion 16 are encapsulated within one transparent protective layer 12, and the LED chips 13 on the other side of the vertical portion 16 are encapsulated within another transparent protective layer 12; or, the plurality of LED chips 13 on the two sides of the vertical portion 16 are encapsulated together within one transparent protective layer 12; or, each LED chip 13 on the two sides of the vertical portion 16 is separately encapsulated within one transparent protective layer 12; and the mode in which the LED chip is encapsulated in the transparent protective layer 12 is not limited herein. Here, the transparent protective layer 12 is in direct contact with the vertical portion 16 of the T-shaped thermal conductive plate 15.

In the LED strip provided by the embodiment of the present disclosure, the plurality of LED chips 13 disposed on the two sides of the vertical portion 16 of the T-shaped thermal conductive plate 15 provided with the circuit layer C are encapsulated onto the vertical portion 16 of the T-shaped thermal conductive plate 15 directly by using the transparent protective layer 12. As compared with the LED strip in the related art which has the LED chip 13 encapsulated on the support frame 11, light emitted from the LED chips 13 in the LED strip according to the embodiment of the present disclosure will not be shielded by the support frame 11, and the light emitting angle of the LED chip 13 is greater than 120°, which increases an emergent angle of the light emitted from the LED chips 13 of the LED strip. In addition, the plurality of LED chips 13 are respectively arranged on the two sides of the vertical portion 16 of the T-shaped thermal conductive plate 15, which further increases the light emitting angle of the LED strip, avoids the dark regions generated due to the small light emitting angle of the LED strip, and further ensures the display effect of the display device.

Further, in the LED strip for a display device which requires more uniform brightness of the display effect, the number and the arrangement mode of the LED chips 13 disposed on the two sides of the vertical portion 16 of the T-shaped thermal conductive plate 15 may be the same as described above, and the LED chips 13 on the two sides are in one to one correspondence. For example: as shown in FIG. 3, there are three LED chips 13 disposed on an upper side (a first side) of the vertical portion 16, there are also three LED chips 13 disposed on a lower side (a second side) of the vertical portion 16, and the LED chips 13 on the first side and the LED chips 13 on the second side overlap with each other correspondingly.

Further, with reference to FIG. 2, FIG. 3 and FIG. 4, the LED chip 13 according to the above-described embodiment can be fixed onto the sides of the vertical portion 16 of the T-shaped thermal conductive plate 15 by a thermal conductive adhesive 17, and the thermal conductive adhesive 17 can conduct heat generated by the LED chip 13 to the T-shaped thermal conductive plate 15 provided with the circuit layer C, so that heat generated by the LED chip 13 is dissipated through the T-shaped thermal conductive plate 15. For example, the T-shaped thermal conductive plate 15 may be an aluminium plate. The aluminium plate has a better thermal conductivity property, and can dissipate the heat generated by the LED chip 13 better and faster.

The LED chip 13 fixed onto the sides of the vertical portion 16 of the T-shaped thermal conductive plate 15 by the thermal conductive adhesive 17 can be electrically connected with the circuit layer C on the T-shaped thermal conductive plate 15 through a lead 14, so as to ensure normal operation of the LED chip 13. For example, the lead 14 may be a gold wire with a purity of 99.99%, so as to minimize resistance of the lead 14. In another example, the LED chip 13 may also be electrically connected with the circuit C on the T-shaped thermal conductive plate 15 by a flip-chip technology, so as to be installed onto the T-shaped thermal conductive plate 15.

In order to further increase the light emitting angle of the LED strip, the transparent protective layer 12 for encapsulating the LED chip 13 may be a resin protective layer. For example, the transparent protective layer 12 is a resin layer mixed with fluorescent powder, which can reduce probability of an adverse firefly (light leakage) phenomenon.

In the above-described embodiment, the T-shaped thermal conductive plate 15 is an example of the support plate. With reference to FIG. 2, the horizontal portion 24 and the vertical portion 16 of the T-shaped thermal conductive plate 15 are respectively examples of the first plate portion 24 and the second plate portion 16 connecting and intersecting with each other. In another example, the support plate may have an L-shaped cross-sectional structure.

The LED strip provided by the above-described embodiment can be fabricated by processes as follow:

Firstly, the circuit layer C is printed onto the T-shaped thermal conductive plate 15; a position corresponding to the LED chip 13 is selected on the circuit layer C of the vertical portion of the T-shaped circuit board 15, and the thermal conductive adhesive 17 which has a high viscosity is coated on the selected position corresponding to the LED chip 13; then the LED chip 13 is placed in the position where the thermal conductive adhesive 17 is coated, and perform high-temperature ultraviolet curing; thereafter, the LED chip 13 and the lead 14 of the circuit layer C are connected by welding, and the LED chips 13 on each side is integrally encapsulated by using the transparent protective layer 12.

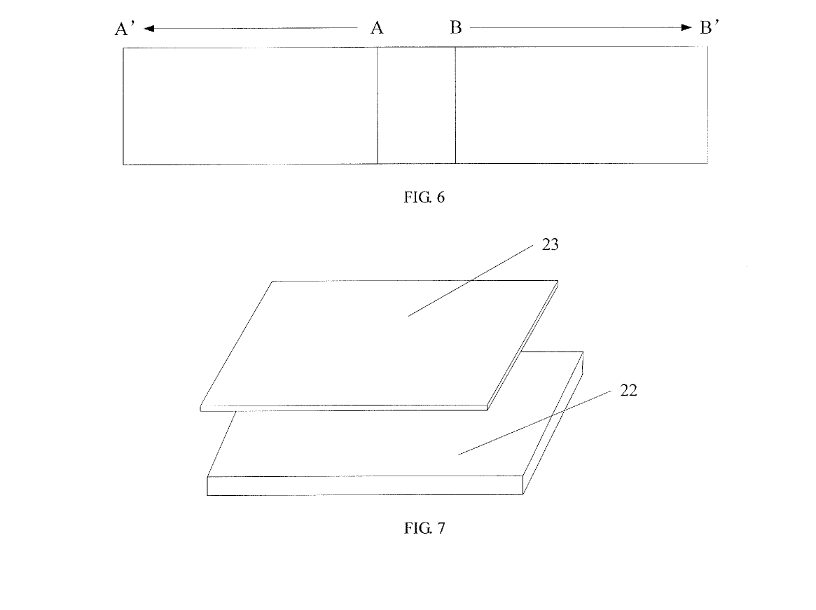

With reference to FIG. 5, an embodiment of the present disclosure further provides a backlight 22, the backlight 22 comprises a back plate 18, a plurality of light guide modules M1 and M2 arranged sequentially at intervals side by side within the back plate 18, and the LED strip according to the above-described embodiment disposed between two adjacent light guide modules M1 and M2. Here, the back plate 18 is an example of the frame.

For example, each of the light guide modules M1 and M2 may include a reflective sheet 19 disposed on a bottom surface within the back plate 18, and a light guide plate 20 disposed on the reflective sheet 19. An optical film 21, for example, a diffusion sheet and the like, may be further disposed above the light guide plate 20 and the LED strip. For example: as shown in FIG. 5, two light guide modules M1 and M2 are disposed on the back plate 18 of the backlight 22, each light guide module includes the reflective sheet 19 and the light guide plate 20, and the LED strip according to the above-described embodiment is disposed between the reflective sheet 19 and the light guide plate 20 of one light guide module M1 and the reflective sheet 19 and the light guide plate 20 of the other light guide module M2. For example, the vertical portion 16 of the T-shaped circuit board 15 of the LED strip is set to be parallel to a light incident surface of the light guide plate 20. The horizontal portion 24 of the T-shaped circuit board 15 of the LED strip is, for example, disposed between the reflective sheets 19 and the back plate 18.

In a related art of a backlight of a side-lit type, a LED strip is located on a side of the light guide plate, and a frame of the display device surrounds the LED strip, and thus, for the display device having the backlight of the side-lit type in the related art, ultra-narrow frame display is relatively difficult to be implemented; and in a related art of a backlight of a direct-lit type, in order to ensure a uniform image of the display device, a distance between the LED strip of the backlight of the direct-lit type and the optical film (for example, the diffusion sheet and the like) located at the topmost needs to be ensured, and thus, for the display device having the backlight of the direct-lit type in the related art, ultra-thin display is relatively difficult to be implemented; in the backlight 22 provided by the embodiment of the present disclosure, the plurality of light guide modules arranged sequentially at intervals are disposed within the back plate 18 of the backlight 22, and the LED strip according to the above-described embodiment is disposed between the adjacent light guide modules; the LED strip disposed between the adjacent light guide modules does not need to be surrounded by a frame. In addition, a light-emitting mode of the LED strip in the backlight according to the embodiment of the present disclosure is similar to that of the backlight of the side-lit type, and thus, on the basis that the uniform image of the display device is ensured, the distance between the LED strip and the optical film (for example, the diffusion sheet and the like) located at the topmost can be reduced, so as to both implement ultra-narrow frame display and ultra-thin display.

Furthermore, in order to facilitate uniformity of light emitted from the backlight 22, the diffusion sheet 21 having diffusion particles dispersed therein is disposed on the light emergent surface of the light guide module. In the diffusion sheet 21, a diffusion particle density gradually decreases in a direction from a position closer to the LED strip to a position away from the LED strip. For example, as shown in FIG. 6, a region of the diffusion sheet 21 between line A and line B corresponds to the LED strip. For example, Lines A and B overlap with the light incident surfaces of the two light guide plates 20 respectively. A diffusion particle density in the diffusion sheet 21 along an A→A′ direction gradually decreases, and a diffusion particle density in the diffusion sheet 21 along a B→B′ direction also gradually decreases; the side A and B are shown as positions closer to the LED strip, and thus, intensity of light provided by the LED strip for the side A and B is relatively large; the diffusion particle density on the side A and B is relatively large, which can reduce intensity of light emitted from the side A and side B to a larger extent; the side A′ and B′ are shown as positions away from the LED strip, and thus, intensity of light provided by the LED strip for the side A′ and side B′ is relatively small, the diffusion particle density on the side A′ and side B′ is relatively small, which can reduce intensity of light emitted from the side A′ and side B′ to a smaller extent, so that the intensities of light emitted from the side A, side B, side A′ and side B′ are almost the same, thus implementing uniformity of light emitted from the backlight 22.

With reference to FIG. 7, an embodiment of the present disclosure further provides a display device, the display device comprising a display panel 23 and the backlight 22 according to the above-described embodiment, the backlight 22 in the display device has the same advantages as the backlight 22 according to the above-described embodiment, which will not be repeated here. Since the backlight 22 according to the above-described embodiment is provided, the display device provided by the embodiment of the present disclosure can both implement ultra-narrow frame display and ultra-thin display, and can avoid the dark region generated due to the small light emitting angle of the LED strip, and further ensure the display effect.

The above-described display device can be any product or part having display function, such as a liquid crystal display panel, electronic paper, a mobile phone, a tablet personal computer, a television, a display, a notebook computer, a digital photo frame, a navigator, etc.

The respective features, structures, materials or characteristics in the above-described implementation modes can be combined in an applicable way in any one or more embodiments or examples.

Although the present disclosure is described in detail hereinbefore with general illustration and embodiments, based on the present disclosure, certain amendments or improvements can be made thereto, which is obvious for those skilled in the art. Therefore, the amendments or improvements made to the present disclosure without departing from the spirit of the present disclosure should be within the scope of the present disclosure.

The present application claims priority of Chinese Patent Application No. 201520241976.8 filed on Apr. 21, 2015, the disclosure of which is incorporated herein by reference in its entirety as part of the present application.

1. An LED strip, comprising:
a support plate provided with a circuit layer, the support plate including a first plate portion and a second plate portion connecting and intersecting with each other;
a plurality of LED chips disposed on a first side and a second side of the second plate portion of the support plate, the respective LED chips being respectively electrically connected with the circuit layer; and
a transparent protective layer for encapsulating the plurality of LED chips on the second plate portion of the support plate,

2. The LED strip according to claim 1, wherein, the second plate portion is perpendicular to the first plate portion.

3. The LED strip according to claim 2, wherein the support plate is a T-shaped thermal conductive plate.

4. The LED strip according to claim 1, wherein, an amount and an arrangement mode of the LED chips on the first side of the second plate portion of the support plate are same as an amount and an arrangement mode of the LED chips on the second side of the second plate portion of the support plate, and the first side is opposite to the second side.

5. The LED strip according to claim 1, wherein, each of the LED chips is fixed to the second plate portion of the support plate by thermal conductive adhesive.

6. The LED strip according to claim 1, wherein, the transparent protective layer is a resin protective layer.

7. The LED strip according to claim 1, wherein, the LED chip is electrically connected with the circuit layer through a lead.

8. The LED strip according to claim 1, wherein, the support plate includes an aluminium plate.

9. A backlight, comprising:
a frame;
at least two light guide modules arranged at intervals in the frame;
the LED strip according to claim 1, being disposed between two adjacent light guide modules.

10. The backlight according to claim 9, wherein, the at least two light guide modules are two light guide modules, and the LED strip is located between the two light guide modules.

11. The backlight according to claim 9, wherein, a diffusion sheet is disposed on a light emergent surface of the light guide module, and in the diffusion sheet, a diffusion particle density gradually decreases along a direction from a position closer to the LED strip to a position away from the LED strip.

12. A display device, comprising a display panel, and the backlight according to claim 9.

13. The LED strip according to claim 2, wherein, an amount and an arrangement mode of the LED chips on the first side of the second plate portion of the support plate are same as an amount and an arrangement mode of the LED chips on the second side of the second plate portion of the support plate, and the first side is opposite to the second side.

14. The LED strip according to claim 3, wherein, an amount and an arrangement mode of the LED chips on the first side of the second plate portion of the support plate are same as an amount and an arrangement mode of the LED chips on the second side of the second plate portion of the support plate, and the first side is opposite to the second side.

15. The LED strip according to claim 2, wherein, each of the LED chips is fixed to the second plate portion of the support plate by thermal conductive adhesive.

16. The LED strip according to claim 3, wherein, each of the LED chips is fixed to the second plate portion of the support plate by thermal conductive adhesive.

17. The LED strip according to claim 4, wherein, each of the LED chips is fixed to the second plate portion of the support plate by thermal conductive adhesive.

18. The LED strip according to claim 2, wherein, the transparent protective layer is a resin protective layer.

19. The LED strip according to claim 3, wherein, the transparent protective layer is a resin protective layer.

20. The LED strip according to claim 4, wherein, the transparent protective layer is a resin protective layer.
